(19) United States
(12) Patent Application Publication
(10) Pub. No.: US 2019/0116526 A1
(43) Pub. Date: Apr. 18, 2019

(54) Device and Method of Handling a Protocol Data Unit Session and a Network Slice

(71) Applicant: HTC Corporation, Taoyuan City (TW)

(72) Inventors: Kundan Tiwari, Taoyuan City (TW); Chih-Hsiang Wu, Taoyuan City (TW)

(21) Appl. No.: 16/162,395

(22) Filed: Oct. 17, 2018

Related U.S. Application Data
(60) Provisional application No. 62/573,172, filed on Oct. 17, 2017.
(60) Provisional application No. 62/573,676, filed on Oct. 17, 2017.

(51) Int. Cl. H04W 36/00; H04W 60/00; H04W 76/11; H04W 76/27; H04W 76/30

(52) U.S. Cl. CPC H04W 36/0022; H04W 36/0033; H04W 76/30; H04W 76/11; H04W 76/27; H04W 60/00

(57) ABSTRACT

A communication device for handling a packet data network (PDN) connection and a network slice comprises at least one storage device; and at least one processing circuit, coupled to the at least one storage device. The at least one storage device stores, and the at least one processing circuit is configured to execute instructions of establishing a PDN connection with a first network; transmitting a Registration Request message of a Registration procedure to a second network, wherein the Registration Request message comprises a protocol data unit (PDU) Session Identifier (ID) identifying the PDN connection; and receiving a Registration Accept message comprising a slice identifier associated to the PDN connection, from the second network.

### CROSS REFERENCE TO RELATED APPLICATIONS

This application claims the benefits of U.S. Provisional Applications No. 62/573,172 filed on Oct. 17, 2017, and No. 62/573,676 filed on Oct. 17, 2017, which are incorporated herein by reference.

### BACKGROUND OF THE INVENTION

### 1. Field of the Invention

The present invention relates to a device and a method used in a wireless communication system, and more particularly, to a device and a method of handling a protocol data unit session and a network slice.

### 2. Description of the Prior Art

A new radio (NR) system, initiated by the third generation partnership project (3GPP), includes a new radio interface and a new radio network architecture that provides a high data rate, a low latency, packet optimization, and an improved system capacity and an improved coverage.

### SUMMARY OF THE INVENTION

The present invention therefore provides a method and related communication device for handling a protocol data unit session and a network slice to solve the abovementioned problem.

A communication device for handling a packet data network (PDN) connection and a network slice comprises at least one storage device; and at least one processing circuit, coupled to the at least one storage device. The at least one storage device stores, and the at least one processing circuit is configured to execute instructions of establishing a PDN connection with a first network; transmitting a Registration Request message of a Registration procedure to a second network, wherein the Registration Request message comprises a protocol data unit (PDU) Session Identifier (ID) identifying the PDN connection; and receiving a Registration Accept message comprising a slice identifier associated to the PDN connection, from the second network.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication system according to an example of the present invention.

FIG. 2 is a schematic diagram of a communication device according to an example of the present invention.

FIG. 3 is a flowchart of a process according to an example of the present invention.

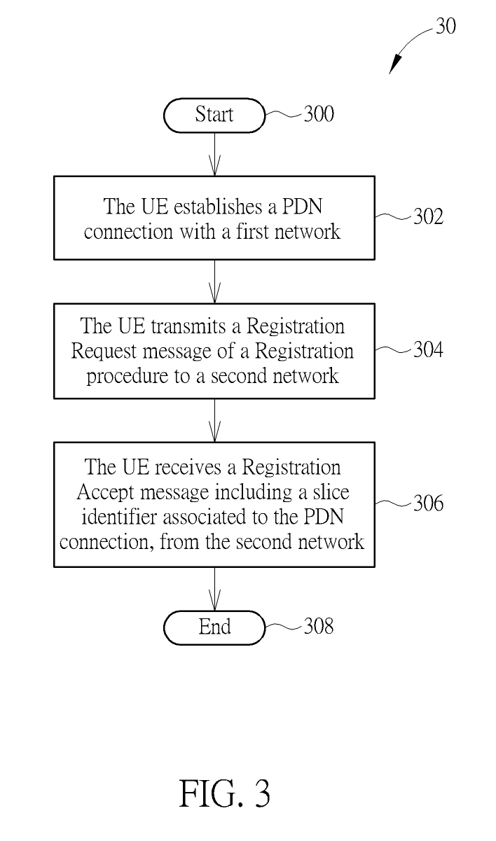

FIG. 4 is a flowchart of a process according to an example of the present invention.

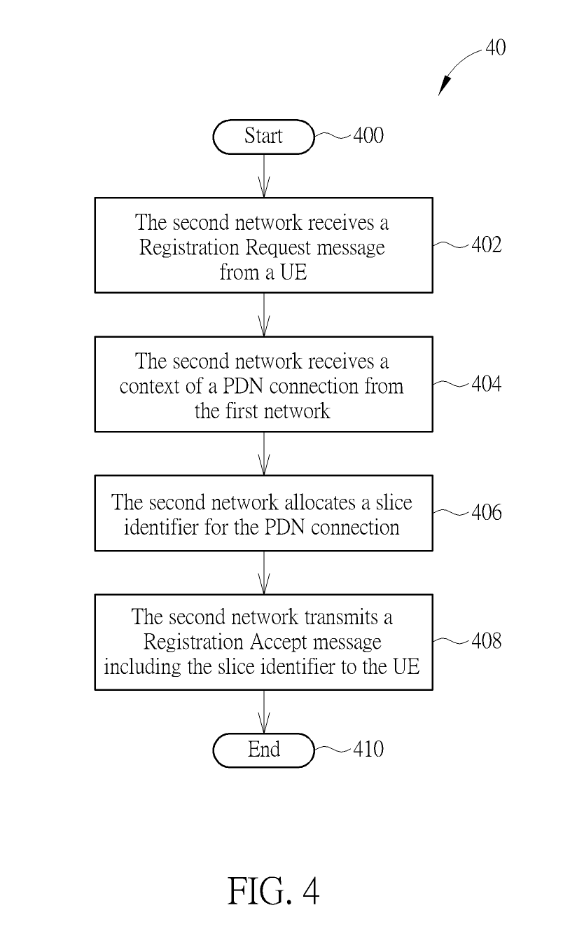

FIG. 5 is a flowchart of a process according to an example of the present invention.

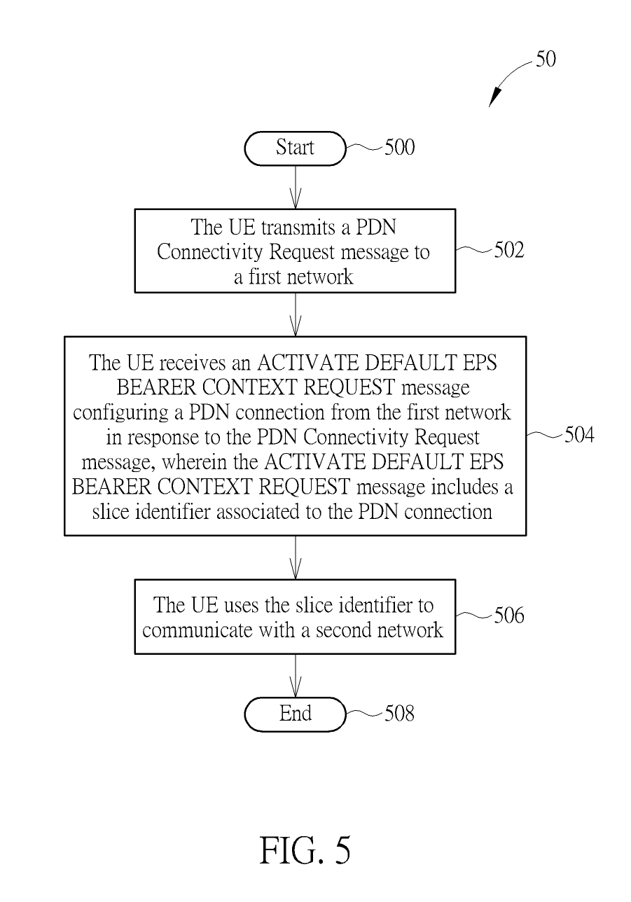

FIG. 6 is a flowchart of a process according to an example of the present invention.

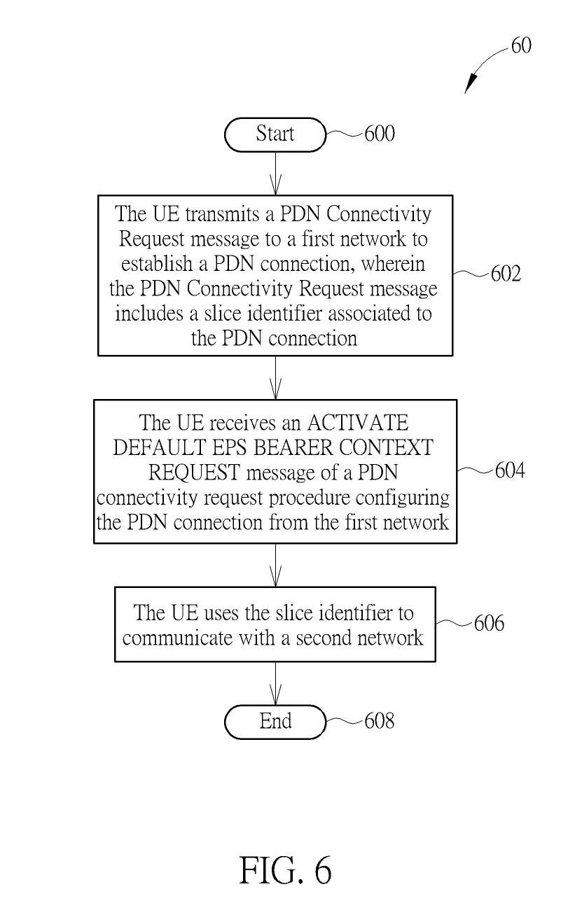

### DETAILED DESCRIPTION

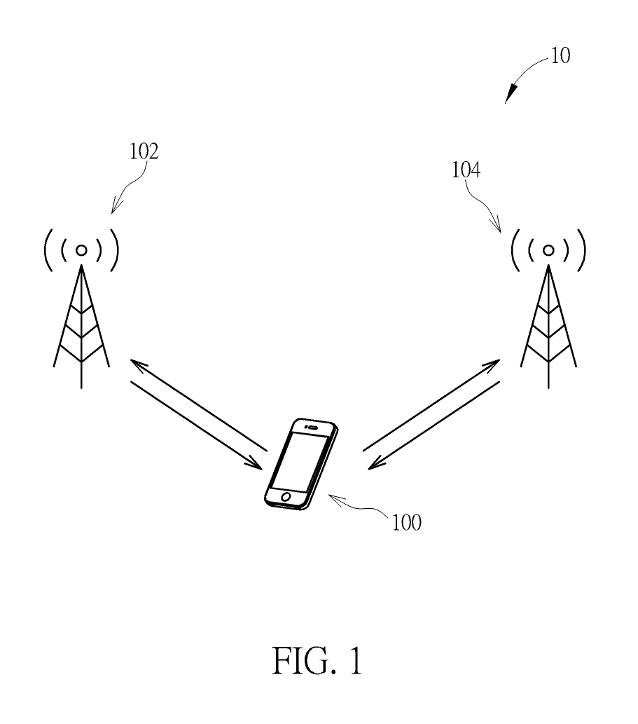

FIG. 1 is a schematic diagram of a wireless communication system 10 according to an example of the present invention. The wireless communication system 10 is briefly composed of a communication device 100, a network 102 and a network 104. In FIG. 1, the communication device 100, the network 102 and the network 104 are simply utilized for illustrating the structure of the wireless communication system 10. Any of the networks 102 and 104 may include a base station (BS). The BS may be an evolved Node-B (eNB), a next generation Node-B (gNB), an enhanced long-term evolution (eLTE) BS, etc.

The communication device 100 may be configured to simultaneously connect to the networks 102 and 104 (e.g., dual connectivity (DC)). That is, the communication device 100 in the DC may perform a transmission/reception via both the networks 102 and 104. For example, the communication device 100 may receive packets from the network 102 at a first carrier frequency and the network 104 at a second carrier frequency, or the communication device 100 may transmit packets to the network 102 at a first carrier frequency and the network 104 at a second carrier frequency. The first carrier frequency and the second carrier frequency may or may not be overlapped.

The communication device 100 may be a user equipment (UE), a mobile phone, a laptop, a tablet computer, an electronic book, a portable computer system, a vehicle or an airplane. In addition, for an uplink (UL), the communication device 100 is a transmitter and the network(s) 102 and/or 104 is a receiver(s), and for a downlink (DL), the network(s) 102 and/or 104 is a transmitter(s) and the communication device 100 is a receiver.

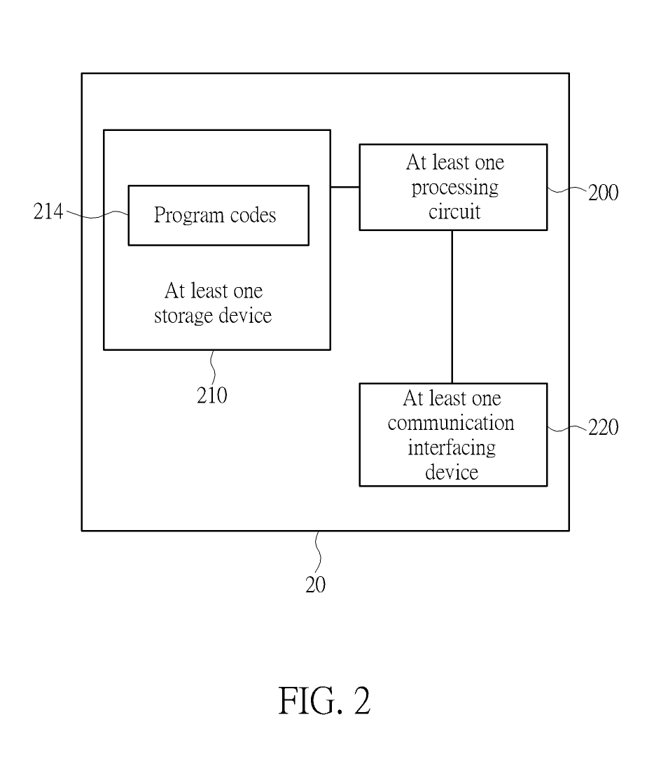

FIG. 2 is a schematic diagram of a communication device 20 according to an example of the present invention. The communication device 20 may be the communication device 100, the network(s) 102 and/or 104 shown in FIG. 1, but is not limited herein. The communication device 20 may include at least one processing circuit 200 such as a microprocessor or Application Specific Integrated Circuit (ASIC), at least one storage device 210 and at least one communication interfacing device 220. The at least one storage device 210 may be any data storage device that may store program codes 214, accessed and executed by the at least one processing circuit 200. Examples of the at least one storage device 210 include but are not limited to a subscriber identity module (SIM), read-only memory (ROM), flash memory, random-access memory (RAM), hard disk, optical data storage device, non-volatile storage device, non-transitory computer-readable medium (e.g., tangible media), etc. The at least one communication interfacing device 220 is preferably at least one transceiver and is used to transmit and receive signals (e.g., data, messages and/or packets) according to processing results of the at least one processing circuit 200.

In the following examples, a UE is used for representing the communication device 100 in FIG. 1, to simplify the illustration of the examples.

According to the prior art, when an application of a UE initiates a data transfer, a Network Slice Selection Policy (NSSP) rule maps the application to a network slice and a UE initiates a protocol data unit (PDU) session establishment corresponding to the network slice. The UE associates a PDU session to the network slice, after the PDU session is established. However, after an intersystem change from an evolved packet core (EPC) to a 5G core network (5GC), it is unknown to which network slice the PDU session (or the PDN connection) is mapped.

A process 30 is utilized in a UE, to determine a network slice to which an established PDU session of the UE is associated. The process 30 includes the following steps:

Step 300: Start.

Step 302: The UE establishes a PDN connection with a first network (e.g., EPC).

Step 304: The UE transmits a Registration Request message of a Registration procedure to a second network (e.g., 5GC).

Step 306: The UE receives a Registration Accept message including a slice identifier associated to the PDN connection, from the second network.

Step 308: End.

In one example, the UE performs a PDN connectivity procedure with the first network to establish the PDN connection (e.g., as specified in 3GPP TS 24.301). The UE may include a PDU Session Identifier (ID) for identifying the PDN connection or for associating the PDU Session ID to the PDN connection in a PDN CONNECTIVITY REQUEST message of the PDN connectivity procedure transmitted to the first network.

In one example, the UE performs a PDN connectivity procedure with the first network to establish the PDN connection (e.g., as specified in 3GPP TS 24.301). The first network may include a PDU Session ID for identifying the PDN connection in an ACTIVATE DEFAULT EPS BEARER CONTEXT REQUEST message of the PDN connectivity procedure transmitted to the UE.

In one example, a PDU Session ID may be used for identifying the PDN connection. The Registration Request message may or may not include the PDU Session ID identifying the PDN connection.

In one example, the first network transmits a context of the PDN connection to the second network in response to a message transmitted by the second network due to the Registration procedure. The first network may or may not transmit the PDU Session ID to the second network in the context. In one example, the second network determines to keep the PDN connection or to release the PDN connection, and notify the determination in the Registration Accept message to the UE. In one example, the Registration Accept message may include the PDU Session ID for identifying the PDN connection, if the second network determines to keep the PDN connection for the UE.

In one example, when the UE moves from a first cell belonging to the first network to a second cell belonging to the second network, the UE transmits the Registration Request message to the second network via the second cell. The second network may configure a network slice associated to the PDN connection. To do so, the second network may allocate a slice identifier (e.g., Single—Network Slice Selection Assistance Information (S-NSSAI)) associated to the PDN connection. The second network may transmit a Registration Accept message indicating the slice identifier associated to the PDN connection.

The Registration Accept message may include the PDU Session ID.

In one example, the Registration Accept message neither includes the PDU Session ID nor includes the slice identifier. In this case, the UE may perform a PDU Session Establishment procedure with the second network by transmitting a PDU Session Establishment Request message to the second network via the second cell. The UE may receive a PDU Session Establishment Accept message responding to the PDU Session Establishment Request message, from the second network via the second cell.

A process 40 is utilized in the second network in the process 30, to assign a network slice associated to a PDN connection of a UE. The process 40 includes the following steps:

Step 400: Start.

Step 402: The second network receives a Registration Request message from a UE.

Step 404: The second network receives a context of a PDN connection from the first network.

Step 406: The second network allocates a slice identifier for the PDN connection.

Step 408: The second network transmits a Registration Accept message including the slice identifier to the UE.

Step 410: End.

Description for the process 30 may be applied to the process 40, and is not repeated herein. The following examples may be applied to the above processes.

In one example, the second network transmits a UE Configuration Update Command message allocating the slice identifier to the UE, if (e.g., when) the second network does not include the slice identifier in the Registration Accept message.

In one example, to indicate the slice identifier associated to the PDU Session ID associated to the PDN connection, the Registration Accept message or the UE Configuration Update Command message may include an IE including a set of PDU Session ID and the slice identifier as follows:

Set 1 {PDU Session ID X, S-NSSAI Y}, X is an integer (e.g., 1, 2, . . . ) and Y is an integer (e.g., 1, 2, . . . ), wherein the S-NSSAI Y may be defined as follows:
S-NSSAI 1=eMBB (enhanced Mobile Broadband)
S-NSSAI 2=MIoT (massive IoT)
S-NSSAI 3=URLLC (ultra-reliable low latency communications)

A process 50 is utilized in a UE, to determine a network slice to which an established PDU session of the UE is associated. The process 50 includes the following steps:

Step 500: Start.

Step 502: The UE transmits a PDN Connectivity Request message to a first network (e.g., EPC).

Step 504: The UE receives an ACTIVATE DEFAULT evolved packet system (EPS) BEARER CONTEXT REQUEST message configuring a PDN connection from the first network in response to the PDN Connectivity Request message, wherein the ACTIVATE DEFAULT EPS BEARER CONTEXT REQUEST message includes a slice identifier associated to the PDN connection.

Step 506: The UE uses (e.g., applies) the slice identifier to communicate with a second network (e.g., 5GC).

Step 508: End.

According to the process 50, the UE associates the PDN connection to the slice identifier. That is, the first network can configure the UE to associate the PDN connection to a slice identified by the slice identifier.

In one example, the UE transmits an ACTIVATE DEFAULT EPS BEARER CONTEXT ACCEPT message to the first network in response to the ACTIVATE DEFAULT EPS BEARER CONTEXT REQUEST message. When the UE moves to the second network from the first network, the UE may transmit a radio resource control (RRC) message to a BS of the second network or a non-access stratum (NAS) message to the second network via the BS. To use the slice identifier configured by the first network, the UE may include the slice identifier in the RRC message or the NAS message. In one example, the RRC message is a RRC request message or a RRC complete message of a RRC connection establishment procedure, a RRC connection resume procedure or a RRC connection reestablishment procedure. In one example, the NAS message is a NAS request message or a NAS complete message of a NAS Registration procedure, or is a NAS request message or a NAS complete message of a NAS Service Request procedure. In one example, the NAS message is a PDU Session Modification Request message or a PDU Session Release Request message.

In one example, the first network (e.g., mobility management entity (MME) of the EPC) determines the slice identifier according to at least one parameter of the PDN connection in the first network. The at least one parameter may include at least one of an Access Point Name (APN) and a PDN type. For example, the first network may include a first slice identifier in the ACTIVATE DEFAULT EPS BEARER CONTEXT REQUEST message, when a first APN and/or a first PDN type is used for the PDN connection. The first network may include a second slice identifier in the ACTIVATE DEFAULT EPS BEARER CONTEXT REQUEST message, when a second APN and/or a second PDN type is used for the PDN connection.

A process 60 is utilized in a UE, to determine a network slice to which an established PDU session of the UE is associated. The process 60 includes the following steps:

Step 600: Start.

Step 602: The UE transmits a PDN Connectivity Request message to a first network (e.g., EPC) to establish a PDN connection, wherein the PDN Connectivity Request message includes a slice identifier associated to the PDN connection.

Step 604: The UE receives an ACTIVATE DEFAULT EPS BEARER CONTEXT REQUEST message of a PDN connectivity request procedure configuring the PDN connection from the first network.

Step 606: The UE uses (e.g., applies) the slice identifier to communicate with a second network (e.g., 5GC).

Step 608: End.

In one example, the UE determines to activate the PDN connection in a slice identified by the slice identifier, and performs Step 602 in response to the determination. The UE may have the slice identifier in a storage device of the UE, or may receive the slice identifier from the first network or the second network before Step 602.

In one example, the UE transmits an ACTIVATE DEFAULT EPS BEARER CONTEXT ACCEPT message to the first network in response to the ACTIVATE DEFAULT EPS BEARER CONTEXT REQUEST message. When the UE moves from the second network from the first network, the UE may transmit a RRC message to a BS of the second network or a NAS message to the second network via the BS. The UE may include the slice identifier in the RRC message or the NAS message. Examples of the RRC message and the NAS message can be referred to the previous description, and are not narrated herein.

In one example, the UE determines the slice identifier according to at least one parameter of the PDN connection in the first network. The at least one parameter may include at least one of an APN and a PDN type. For example, the UE may include a first slice identifier in the PDN CONNECTIVITY REQUEST message, when a first APN and/or a first PDN type is used for the PDN connection. The UE may include a second slice identifier in the PDN CONNECTIVITY REQUEST message, when a second APN and/or a second PDN type are used for the PDN connection.

Examples of the processes 30 and 40 may be applied to the processes 50 and 60, and are not repeated herein.

In the above processes, the UE may convert, map or transfer the PDN connection to a PDU Session. In this case, the PDN connection may represent the PDU session converted/mapped/transferred from the PDN connection.

It should be noted that although the above examples are illustrated to clarify the related operations of corresponding processes. The examples can be combined and/or modified arbitrarily according to system requirements and/or design considerations.

Those skilled in the art should readily make combinations, modifications and/or alterations on the abovementioned description and examples. The abovementioned description, steps and/or processes including suggested steps can be realized by means that could be hardware, software, firmware (known as a combination of a hardware device and computer instructions and data that reside as read-only software on the hardware device), an electronic system, or combination thereof. An example of the means may be the communication device 20. In the above description, description for the first network may be compiled into the program codes 214 in a first BS, and description for the second network may be compiled into the program codes 214 in a second BS.

To sum up, the present invention provides a method and related communication device for efficiently handling a PDU session and a network slice. Thus, the problem that a communication device does not have a network slice for a PDU session when connecting to another network is solved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communication device for handling a packet data network (PDN) connection and a network slice, comprising:
at least one storage device; and
at least one processing circuit, coupled to the at least one storage device, wherein the at least one storage device stores, and the at least one processing circuit is configured to execute instructions of:
establishing a PDN connection with a first network;
transmitting a Registration Request message of a Registration procedure to a second network; and
receiving a Registration Accept message comprising a slice identifier associated to the PDN connection, from the second network.

2. The communication device of claim 1, wherein the instructions further comprise:
performs a PDN connectivity procedure with the first network to establish the PDN connection;
wherein the communication device comprises a PDU Session Identifier (ID) for identifying the PDN connection in a PDN CONNECTIVITY REQUEST message of the PDN connectivity procedure transmitted to the first network.

3. A second network for handling a packet data network (PDN) connection and a network slice, comprising:
at least one storage device; and
at least one processing circuit, coupled to the at least one storage device, wherein the at least one storage device stores, and the at least one processing circuit is configured to execute instructions of:
receiving a Registration Request message from a communication device;
receiving a context of a PDN connection from a first network;
allocating a slice identifier for the PDN connection; and
transmitting a Registration Accept message comprising the slice identifier to the communication device.

4. The second network of claim 3, wherein the instructions further comprise:
transmitting a UE Configuration Update Command message allocating the slice identifier to the communication device, when the second network does not comprise the slice identifier in the Registration Accept message.

5. The second network of claim 3, wherein the instructions further comprise:
determining to keep the PDN connection or to release the PDN connection; and
notifying the determination in the Registration Accept message to the communication device.

6. The second network of claim 3, wherein the Registration Accept message comprises a PDU Session Identifier (ID) for identifying the PDN connection, if the second network determines to keep the PDN connection for the communication device.

7. A communication device for handling a packet data network (PDN) connection and a network slice, comprising:
at least one storage device; and
at least one processing circuit, coupled to the at least one storage device, wherein the at least one storage device stores, and the at least one processing circuit is configured to execute instructions of:
transmitting a PDN Connectivity Request message to a first network;
receiving an ACTIVATE DEFAULT evolved packet system (EPS) BEARER CONTEXT REQUEST message configuring a PDN connection from the first network in response to the PDN Connectivity Request message, wherein the ACTIVATE DEFAULT EPS BEARER CONTEXT REQUEST message comprises a slice identifier associated to the PDN connection; and
using the slice identifier to communicate with a second network.

8. The communication device of claim 7, wherein the instructions further comprise:
transmitting a radio resource control (RRC) message to a BS of the second network or a non-access stratum (NAS) message to the second network via the BS, when the communication device moves to the second network from the first network.
